(19) United States
(12) Patent Application Publication
(10) Pub. No.: US 2019/0058367 A1
(43) Pub. Date: Feb. 21, 2019

(54) ROTOR AND ELECTRICAL MACHINE

(71) Applicant: SIEMENS AKTIENGESELLSCHAFT, München (DE)

(72) Inventors: Oana Mucha, Nürnberg (DE); Wolfgang Wetzel, Herzogenaurach (DE)

(21) Appl. No.: 16/078,230

(22) PCT Filed: Feb. 6, 2017
(86) PCT No.: PCT/EP2017/052538

§ 371 Date: Aug. 21, 2018

(30) Foreign Application Priority Data
Feb. 23, 2016 (DE) 10 2016 202 741.7

(51) Int. Cl. H02K 1/32; H02K 1/27; H02K 9/06

(52) U.S. Cl. CPC H02K 1/32; H02K 9/06; H02K 1/278

(57) ABSTRACT

The disclosure relates to a weight-optimized, meridian-accelerated rotor including permanent magnets securely supplied with a required cooling during use. The disclosure further relates to a corresponding electrical machine, in which the problem of demagnetization of existing permanent magnets due to rotor temperatures that are too high is avoided. The rotor or the rotor of an affected electrical machine has an annular structure on the outside radius for receiving the permanent magnets. The rotor also has a conical hub structure on an inside radius and a plurality of at least rib-shaped or blade-shaped structures between the annular structure and the conical hub structure in order to form a mechanical connection of the annular structure and conical hub structure.

The present patent document is a § 371 nationalization of PCT Application Serial Number PCT/EP2017/052538, filed Feb. 6, 2017, designating the United States, which is hereby incorporated by reference, and this patent document also claims the benefit of German Patent Application No. DE 10 2016 202 741.7, filed Feb. 23, 2016, which is also hereby incorporated by reference.

### TECHNICAL FIELD

The disclosure relates to a rotor and to an electrical machine.

### BACKGROUND

A rotor having permanent magnets at an outer radius is a meridian-accelerated rotor which, as set out at least partially below, may also be termed a permanent magnet rotor.

Depending on the alloying composition, the magnet material of the permanent magnets of a permanent magnet rotor has a maximum permissible upper limit to the temperature at which it may be used. If this is exceeded, irreversible demagnetization of the magnet material may occur, which destroys the function of the permanent magnet rotor.

During operation, targeted air cooling of the rotor counteracts impermissible heating of the rotor magnets due to eddy current losses and heat input, for example, via the associated stator.

Depending on the chosen manner of targeted air cooling, the production of the permanent magnet rotor is more or less onerous and the resulting cooling effect is either more or less pronounced.

It is generally known that self-ventilated permanent magnet rotors are, for example, constructed such that, (in addition to the actual rotor active part with its permanent magnets), there is an additional fan (e.g., an axial fan or a radial fan with a “push” or “pull” air flow) provided concentrically on the shaft of the rotor and as a separate component. Alternative known solutions include an external fan for generating a cooling air flow. These solutions disadvantageously increase the complexity and weight of the overall construction of the rotor, or of an electrical machine equipped therewith. For example, European Patent Publication No. EP 1 722 462 A1 discloses an electrical machine.

### SUMMARY AND DESCRIPTION

The scope of the present disclosure is defined solely by the appended claims and is not affected to any degree by the statements within this summary. The present embodiments may obviate one or more of the drawbacks or limitations in the related art.

The present disclosure has the object of specifying a rotor of the type mentioned in the introduction, whose permanent magnets, during use, are reliably supplied with a necessary cooling, this being done in such a manner that the production of the rotor is not onerous and the disadvantageous problem of increased weight for the cooling is improved in comparison to known solutions. The present disclosure also has the object of specifying an electrical machine of the type mentioned in the introduction, in which the problem of demagnetization of the permanent magnets present for the rotor, due to excessive temperature during operation, is solved without the drawbacks, in terms of complexity of production and weight, of known solutions.

This object is achieved in relation to the rotor, proceeding from a rotor of the type mentioned in the introduction, with a rotor having the features described herein. This object is also achieved in relation to the electrical machine, proceeding from an electrical machine of the type mentioned in the introduction, with an electrical machine having the features described herein.

The rotor has, at the outer radius, an annular structure with permanent magnets arranged therein. The rotor has a conical hub structure at an inner radius. Between the annular structure and the conical hub structure, the rotor has a multiplicity of at least rib-shaped or blade-shaped structures for mechanically connecting the annular structure and the conical hub structure.

The electrical machine includes the above-specified rotor.

The effect of the measures, both in the case of a meridian-accelerated rotor and also in the case of an electrical machine having such a rotor, is less onerous production while more reliably providing necessary cooling for the permanent magnets of the meridian-accelerated rotor and avoiding an increase in weight caused by additional, separate cooling units. In particular, there is no need for an additional fan, such as an axial fan or a radial fan with a “push” or “pull” air flow, as a separate component provided concentrically on the shaft of the rotor. This advantageously dispenses with the complex manufacture of the rotor and the associated increase in overall weight. Thus, the measures advantageously have a positive influence on both ventilation aspects and production aspects.

This is achieved in that a mechanical rotating support structure, which is present, is simultaneously used as a rotating heat exchanger.

Annular structures are the geometrically most expedient design shape for a rotor.

A particularly good cooling action is achieved when the multiplicity of structures arranged between the annular structure at the outer radius of the rotor and the conical hub structure arranged at an inner radius of the rotor are designed as fan blades, made of a material having good thermal conductivity such as aluminum, for mechanically connecting the annular structure at the outer radius of the rotor and the conical hub structure at an inner radius of the rotor.

The cooling action may be further positively influenced by an appropriate profiling of the fan blades.

Planar fan blades simplify production.

Fan blades designed as the fan blades of a meridian-accelerated axial blower optimize the cooling action obtained thereby.

If the multiplicity of structures between the annular structure at the outer radius of the rotor and the conical hub structure arranged at an inner radius of the rotor is optimized in terms of air delivery taking into account the preferred direction of rotation inherent to the rotor, there results a maximum cooling effect for, for example, the permanent magnets of the rotor.

If at least the annular structure arranged at the outer radius of the rotor for receiving the permanent magnets, or the conical hub structure arranged at an inner radius of the rotor, or the multiplicity of structures arranged between the annular structure at the outer radius of the rotor and the conical hub structure arranged at an inner radius of the rotor, is/are hollow, having or not having arranged therein a phase-change medium that is configured to the thermal ratios, then it is possible on one hand to save weight and on the other hand to achieve even greater heat transfer rates.

Corresponding advantageous effects and advantageous actions apply for an electrical machine equipped with a rotor of this kind.

### BRIEF DESCRIPTION OF THE DRAWINGS

There follows a more detailed explanation of exemplary embodiments, with reference to the drawings, in which:

FIG. 1 depicts a meridian-accelerated rotor according to an embodiment, in a three-dimensional perspective schematic drawing seen from the front.

FIG. 2 depicts a rear view of the rotor of FIG. 1.

FIG. 3 depicts a diagrammatic illustration of a longitudinal section through the rotor of FIG. 1.

FIG. 4 depicts a diagrammatic illustration of a longitudinal section through the rotor of FIG. 1, in a configuration according to what is referred to as the heat pipe principle.

### DETAILED DESCRIPTION

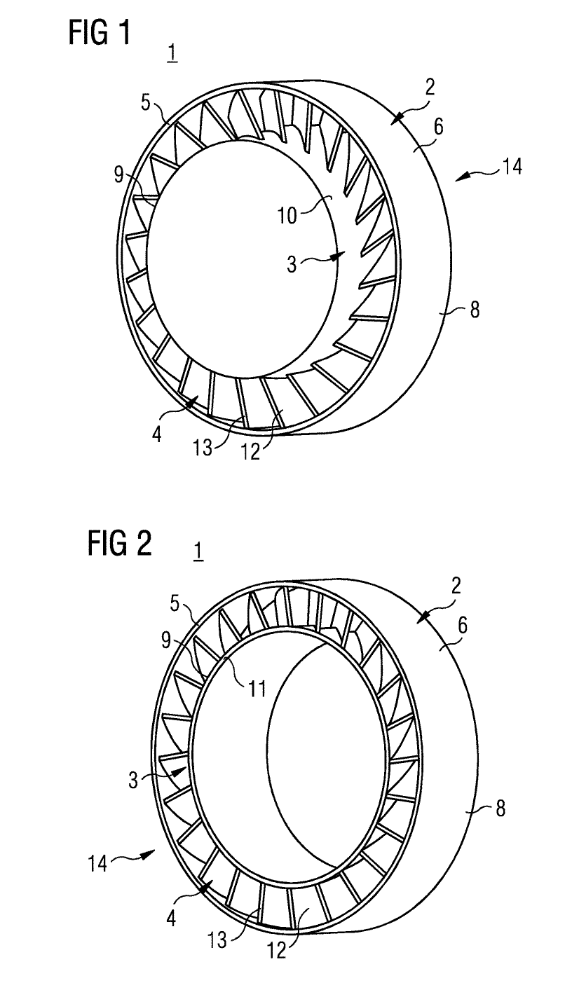

In the following, FIGS. 1 to 4 will be described simultaneously.

The structure of the rotor 1 may be split into three sections 2, 3, 4.

In a first section 2, there is arranged, on an outer radius 5 of the rotor 1, an annular structure 6 for receiving permanent magnets 7 that are not explicitly depicted in FIGS. 1 and 2. In the present exemplary embodiment, this annular structure is formed by an outer ring 8.

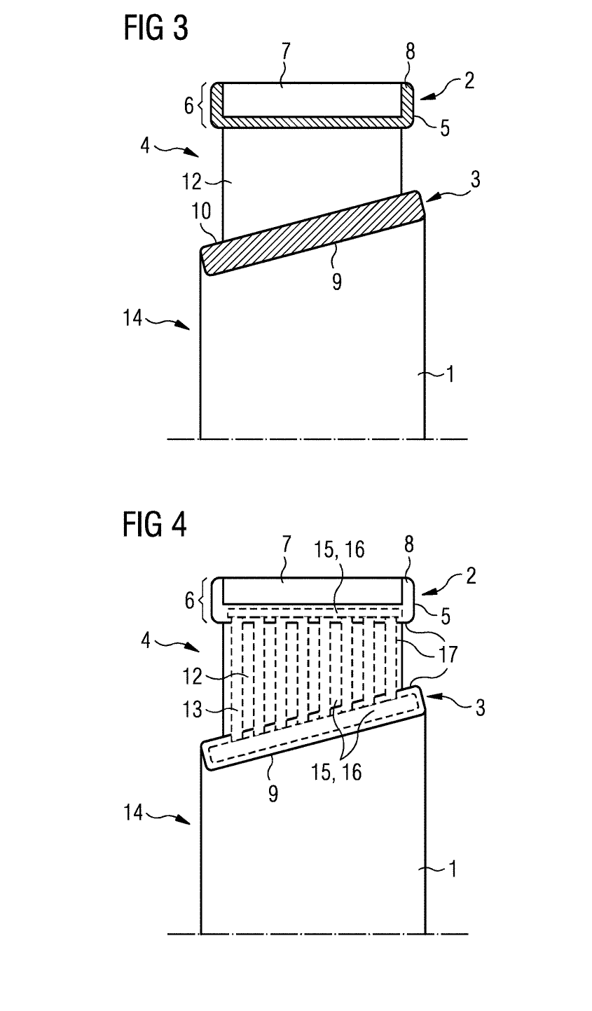

In a second section 3, a conical hub structure 10 (see FIGS. 1, 3) is arranged on an inner radius 9. In the present exemplary embodiment, the conical hub structure 10 is formed by a conical inner ring 11 (see FIG. 2).

A multiplicity of rib-shaped or blade-shaped structures 12 for mechanically connecting the outer and inner rings 8, 11 are arranged in a third section 4 between the outer and inner ring 8, 11. In the present exemplary embodiment, these structures 12 include fan blades 13. That is to say that, at a suitable location, the mechanical connecting structures are simultaneously used not only for the mechanical integrity of the mechanical structural parts, but also equally for improving the discharge of lost heat.

Owing to the design of the rotor 1 with the stated three sections, there is arranged between the annular structure 6 and the conical hub structure 10 a blade duct through which ambient air flows when the rotor 1 rotates in its assigned preferred direction of rotation. The outer boundary of the flowed-through blade duct is cylindrical, that is to say that it has a constant diameter. The conical hub has a diameter that increases in the axial direction.

With the outer boundary being cylindrical, and if the relative velocities w₁ and w₂ at the inlet and the outlet are equal, w₁=w₂, then the outer flow line has constant pressure, that is to say that the rotor 1 generates only kinetic energy. Accordingly, the flow lines closer to the hub experience greater acceleration. For that reason, the rotor 1 described here is said to be “meridian-accelerated”.

The advantages of this design lie in the fact that the heat transfer in the blade ducts is maximized, and also it is possible to dispense with profiling of the fan blades.

Lost power of the rotor 1 is conveyed by thermal conduction from the outer ring 8 into the fan blades 13 and, to a lesser extent, into the inner ring 11. By virtue of the shape of the fan blades 13, when the permanent magnet rotor, (this being an alternative designation for the rotor 1), is in rotation, cooling air, as mentioned in the introduction, is pumped from an intake side to a discharge side.

A rotor 1 as depicted in FIGS. 1 to 4 is, as mentioned, a meridian-accelerated rotor 1. It rotates about a stator 14 (as suggested in FIGS. 1 to 4). The rotor 1 is a meridian-accelerated rotor 1 because the flow lines of the medium flowing through the rotor experience greater acceleration closer to the hub. Rotors 1 of this kind have a preferred direction of rotation.

An advantageous embodiment for such a preferred direction of rotation is that of a meridian-accelerated axial blower having non-decelerated relative velocity of the flow in the blade ducts, w₁=w₂. This makes it possible to dispense with the profiling of the fan blades 13.

In the rotating reference system, there is a relative velocity between the fan blades 13 and the pumped air. Because the fan blades 13 simultaneously serve as ribs of a plate heat exchanger, or rotating plate heat exchanger, now acting here, the lost heat of the rotor 1 is lost effectively by convection to the pumped air or the surrounding fluid, because there is a large surface area and a high relative velocity.

The heat transfer capacity or cooling capacity of the rotor 1 is further optimized by making the internal structures 15 of the outer and inner ring 8, 11, and of the fan blades 13, hollow rather than solid. A phase-change medium 16, which by the liquid-gaseous phase transition improves the transport of heat from the hot permanent magnets 7 as heat source (e.g., evaporation) to the well-cooled surfaces 17 of the fan blades 13 and of the outer and inner rings 8, 11 (e.g., condensation), may be introduced into these internal structures 15. This heat exchanger principle is also known as the “heat pipe principle”. The centrifugal forces acting in this context further reinforce this effect.

All in all, FIGS. 1 to 4 depict a rotor 1, or a permanent magnet rotor, in which its aerodynamically optimized supporting structure simultaneously serves as a rotating plate heat exchanger. The shaping of the outer and inner rings 8, 11, and of the fan blades 13 connecting these, is constructed in such a way that it is well suited to the specific requirements of effective rotor cooling, and specifically so as to produce separation-free axial incident flow to the rotor cooling ducts in the rotating reference system. This results in improved cooling action with lower noise generation. The achieved flow conditions in the blade ducts of the rotor 1 result in a very effective use of material, that is to say that the ratio of discharged lost power to the mass of the rotor is favorable. Implementing the so-called heat pipe principle additionally increases the effectiveness of the cooling.

When such a rotor 1 is used in corresponding electrical machines, the power density of the electrical machine in question is advantageously increased.

Although the disclosure has been illustrated and described in detail by the exemplary embodiments, the disclosure is not restricted by the disclosed examples and the person skilled in the art may derive other variations from this without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A rotor having a preferred direction of rotation, the rotor comprising:
an annular structure arranged at an outer radius of the rotor;
permanent magnets mounted within the annular structure;
a conical hub structure arranged at an inner radius of the rotor, wherein the conical hub structure is a conical inner ring having a diameter that increases in the axial direction; and
a plurality of rib-shaped or blade-shaped structures configured to mechanically connect the annular structure and the conical hub structure, wherein the plurality of rib-shaped or blade-shaped structures is provided between the annular structure and the conical hub structure, therein providing a blade duct through which ambient air flows when the rotor rotates in the preferred direction of rotation,
wherein an outer boundary of the flowed-through blade duct is cylindrical and has a constant diameter.

2. The rotor of claim 1, wherein the annular structure at the outer radius of the rotor is an outer ring.

3. The rotor of claim 1, wherein the plurality of rib-shaped or blade-shaped structures is a plurality of fan blades.

4. The rotor of claim 1, wherein the plurality of rib-shaped or blade-shaped structures is a plurality of non-profiled or profiled fan blades.

5. The rotor of claim 1, wherein the plurality of rib-shaped or blade-shaped structures is a plurality of planar fan blades.

6. The rotor of claim 1, wherein the plurality of rib-shaped or blade-shaped structures is a plurality of profiled fan blades of a meridian-accelerated axial blower.

7. The rotor of claim 1, wherein the plurality of rib-shaped or blade-shaped structures is configured to be optimized for a blower with respect to the preferred direction of rotation of the rotor.

8. The rotor of claim 1, wherein one or more of the annular structure, the conical hub structure, or the plurality of rib-shaped or blade-shaped structures is hollow, with or without a particular heat-conducting phase-change medium arranged therein.

9. An electrical machine configured as a meridian-accelerated axial blower, the electrical machine comprising:
a stator; and
a rotor having a preferred direction of rotation, the rotor comprising:
an annular structure arranged at an outer radius of the rotor;
permanent magnets mounted within the annular structure;
a conical hub structure arranged at an inner radius of the rotor, wherein the conical hub structure is a conical inner ring having a diameter that increases in the axial direction; and
a plurality of rib-shaped or blade-shaped structures configured to mechanically connect the annular structure and the conical hub structure,
wherein the plurality of rib-shaped or blade-shaped structures is provided between the annular structure and the conical hub structure, therein providing a blade duct through which ambient air flows when the rotor rotates in the preferred direction of rotation,
wherein an outer boundary of the flowed-through blade duct is cylindrical and has a constant diameter.

10. The rotor of claim 2, wherein the plurality of rib-shaped or blade-shaped structures is a plurality of fan blades.

11. The rotor of claim 2, wherein the plurality of rib-shaped or blade-shaped structures is a plurality of non-profiled or profiled fan blades.

12. The rotor of claim 2, wherein the plurality of rib-shaped or blade-shaped structures is a plurality of planar fan blades.

13. The rotor of claim 2, wherein the plurality of rib-shaped or blade-shaped structures is a plurality of profiled fan blades of a meridian-accelerated axial blower.

14. The rotor of claim 2, wherein the plurality of rib-shaped or blade-shaped structures is configured to be optimized for a blower with respect to the preferred direction of rotation of the rotor.

15. The rotor of claim 2, wherein one or more of the annular structure, the conical hub structure, or the plurality of rib-shaped or blade-shaped structures is hollow, with or without a particular heat-conducting phase-change medium arranged therein.

16. The rotor of claim 15, wherein the plurality of rib-shaped or blade-shaped structures is a plurality of fan blades.

17. The rotor of claim 15, wherein the plurality of rib-shaped or blade-shaped structures is a plurality of non-profiled or profiled fan blades.

18. The rotor of claim 15, wherein the plurality of rib-shaped or blade-shaped structures is a plurality of planar fan blades.

19. The rotor of claim 15, wherein the plurality of rib-shaped or blade-shaped structures is a plurality of profiled fan blades of a meridian-accelerated axial blower.

20. The rotor of claim 15, wherein the plurality of rib-shaped or blade-shaped structures is configured to be optimized for a blower with respect to the preferred direction of rotation of the rotor.
